(19) United States
(12) Patent Application Publication
(10) Pub. No.: US 2018/0097820 A1
(43) Pub. Date: Apr. 5, 2018

(54) MANAGING CONTENT UPLOAD AND CONTENT RETRIEVAL

(71) Applicant: Adobe Systems Incorporated, San Jose, CA (US)

(72) Inventors: Damien Antipa, Saint-Louis (FR); Antonio Sanso, Basel (CH)

(21) Appl. No.: 15/284,080

(22) Filed: Oct. 3, 2016

(51) Int. Cl. H04L 29/06

(52) U.S. Cl. CPC H04L 63/14

(57) ABSTRACT

A method for managing content upload and content retrieval is provided. The method includes receiving a first content for upload to a first address in a first domain. A first identifier for the first content is then generated. A second address in a second domain is determined using the first identifier. The first content is then stored at the second address. Further, a request for the first content directed to the first address is received. The first content is then served from the second address.

### BACKGROUND

Often, in a production environment or a development environment, a user uploads content at an address in a domain and the content in the domain is accessible by the same or different users of the domain. The uploaded content can be of various types ranging from a non-executable file, considered as safe content, to an executable file, considered as malicious content. The malicious content uploaded by the user is a security risk for other users as the malicious content runs under the domain allowing the malicious content to access domain restricted content such as cookies and local storage. For example, a JavaScript content uploaded by the user to the address “www.mysafedomain.com/home/malicioususer/upload.js” in the domain “mysafedomain.com” is able to steal another user's cookies or perform operations under another user's login session. Therefore, there is a need to manage content upload and content retrieval to mitigate security risks.

In one existing solution, a domain owner does not allow users to upload malicious content and restricts uploads to only safe content. However, not all executable files are malicious content and hence, it may be desired by the user to upload such content which is theoretically categorized as malicious content by the domain owner but practically is not malicious content. Further, such existing solution severely restricts the type of content that can be uploaded and reduces the use of the solution. In addition, it is difficult to decide which content is malicious and which content is not.

In another existing solution, a HTTP response header is used during content upload and content retrieval. The header enforces that the content which includes JavaScript or other malicious content is not handled as a document but is rather handled as a file download within a browser. This solution is not safe because some browsers do not support the header. In addition, browser plugins, such as Applets and Flash, may ignore the HTTP response header and it is difficult to decide which files have to return the HTTP response header and which not.

Therefore, despite existing solutions, there is an unmet need for a method and an apparatus for content upload and content retrieval which is secure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for managing content upload and content retrieval is provided. The method includes receiving a first content for upload to a first address in a first domain. A first identifier for the first content is then generated. A second address in a second domain is determined using the first identifier. The first content is then stored at the second address. Further, a request for the first content directed to the first address is received. The first content is then served from the second address.

An apparatus for managing content upload is also provided. The apparatus includes a memory and one or more processors. The processors are electronically coupled to the memory and are configured to perform a method for managing content upload in conjunction with the memory. The method includes receiving a first content for upload to a first address in a first domain. A first identifier for the first content is then generated. A predefined address in the second domain is identified and modified using the first identifier to determine a second address. The first content is stored at the second address for access via a request directed to the first address.

A non-transitory computer readable medium for storing computer instructions that when executed by at least one processor causes the at least one processor to perform a method for managing content retrieval is also provided. The method includes receiving a request for a first content. The request is directed to a first address in a first domain. A second address is identified in a second domain from a mapping stored for the first address. The second address is generated by modifying a predefined address in second domain using a first identifier uniquely generated for the first content. The first content is then provided from the second address.

### BRIEF DESCRIPTION OF THE DRAWINGS

FIG. 1 is a block diagram of an environment using which various embodiments of the invention may be practiced;

FIG. 2A is a block diagram of an apparatus for managing content upload, according to one embodiment;

FIG. 2B is a block diagram of an apparatus for determining a second address, according to one embodiment;

FIG. 2C is a block diagram of an apparatus for managing content retrieval, according to one embodiment;

FIG. 3 is a block diagram of a user device, according to one embodiment;

FIG. 4 is a block diagram of a content management server, according to one embodiment;

FIG. 5 is a flowchart of a method for managing content upload, according to one embodiment;

FIG. 6 is a flowchart of a method for managing content retrieval, according to one embodiment; and

FIG. 7 is a flowchart of a method for managing content upload and content retrieval, according to one embodiment.

While the method and apparatus is described herein by way of example for several embodiments and illustrative drawings, those skilled in the art will recognize that the method and apparatus provided herein is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. Moreover, although the terms “step” and/or “block” are used herein to connote different elements of methods employed, the terms should not be interpreted as implying any particular order among or between various steps herein disclosed unless and except when the order of individual steps is explicitly described.

### DETAILED DESCRIPTION OF EMBODIMENTS

### Overview

In accordance to embodiments of the present invention and as described in more detail below, a method for managing content upload and content retrieval is provided.

In one embodiment, a user uploads first content at a first address in a first domain. The first address is an electronic address accessible from a device of the user. The device of the user also includes a content management system, such as Adobe® Experience Manager, for managing content upload and content retrieval. The user may want to upload the first content in a production environment or a development environment. The upload can be performed via the content management system. The content management system includes a configurable filter which is configured with a predefined address in a second domain. The content management system receives the request for uploading the first content to the first address in the first domain. The content management system generates a first identifier for the first content. The first identifier uniquely identifies the first content. Any identifier generator can be used for generating the first identifier. The content management system then modifies the predefined address using the first identifier to generate a second address in the second domain. The content is uploaded at the second address and a mapping of the second address is stored against the first address for the first content. Whenever a request for the first content directed to the first address is received, the first content is fetched from the second address and provided to the user.

The second domain is different than the first domain and hence, processes running in the second domain do not have access to the processes in the first domain, and vice versa. For example, the first content does not have any access to data specific to the first domain. So, even if request for upload of malicious content is received at the first address the malicious content is uploaded at the second address and served from there. This prevents the malicious content running in the second domain to access any other content of the first address and prevents access to cookies and other users' sessions in the first domain. For example, the content uploaded to the first address “www.mysafedomain.com/home/malicioususer/upload.js” by the user is not directly downloaded through the first address. A HTTP redirect ends up on the second address “usergenerated.mysafedomain.com/some-secret-identifier-for-this-upload”. Therefore, the malicious content, i.e. the executed JavaScript code, runs in the second domain “usergenerated.mysafedomain.com” rather than the first domain “www.mysafedomain.com”. While the user is logged into under the first domain “www.mysafedomain.com” using a browser all confidential content, such as cookies are available at the first domain, however, the malicious content is accessed through the second domain “usergenerated.mysafedomain.com” and hence no confidential content is available to the user or to the malicious content due to browsers origin policy. Under the browsers origin policy, a browser does not provide access to content in the first domain by a process running in the second domain. Therefore, no session exists on the first domain and the malicious content cannot extract any data or access the first domain under the logged in identity.

In some embodiments, the content management system also receives a request for uploading a second content to the first address in the first domain. The request for uploading second content can be from the same user device or a different user device. The content management system generates a second identifier for the second content. The second identifier uniquely identifies the second content. The content management system then modifies the predefined address using the second identifier to generate a third address in the second domain. The content is uploaded at the third address and a mapping of the third address is stored against the first address for the second content. Whenever a request for the second content directed to the first address is received, the second content is fetched from the third address and provided to the user.

Thus, the methods and systems described herein address and remedy the Internet-based problem of storing and serving potentially malicious content in a manner that allows the content to be stored and accessible but also prevents the content from compromising data on a particular domain or otherwise posing a security risk. Furthermore, one or more embodiments of the methods and systems described herein provide the foregoing benefits automatically (i.e., user does not need to indicate potentially malicious content or otherwise indicate that the content needs to be specially handled), with a browser agnostic solution (i.e., works in any browser), and without requiring overhead or substantial hardware/software changes on a user's device. Indeed, part of the power of one or more embodiments disclosed herein is the ability to resolve the foregoing problems with a non-conventional and non-generic arrangement of pieces that do not require substantial modifications to existing content management systems. Furthermore, by providing a more efficient, automatic, and comprehensive solution than conventional solutions, the systems and methods described herein provide a software-based invention that improves the performance of the computer system itself.

### Terms Descriptions

Content herein refers to any electronic content. Examples of the content include, but are not limited to, an image, video, JavaScript file, executable file, non-executable file, document, malicious script or any other file.

An address refers to an electronic address at which content can be uploaded. Examples of the address include, but are not limited to, a uniform resource locator (URL), internet protocol (IP) address, or any other electronic address. The address at which a content needs to be uploaded is referred to as a first address and the address which is determined from a predefined address by modifying the predefined address using an identifier is referred to as a second address. For example, “www.mysafedomain.com/home” is a first address and “www.usergenerated.mysafedomain.com/home/ . . . /some unique identifier for the content” is a second address.

A domain herein refers to a domain name. The addresses can correspond to one or more domains. The domain corresponding to an address at which the content needs to be uploaded is referred to as a first domain and the address at which the content is actually uploaded and which also corresponds to the predefined address is referred to as the second domain. For example, “www.mysafedomain.com/home” is the first address in the first domain “mysafedomain.com” and “www.usergenerated.mysafedomain.com/home/ . . . /some unique identifier for the content” is the second address in the second domain “www.usergeneratedmysafedomain.com”. The processes or content running in the second domain “usergeneratedmysafedomain.com” do not have access to content or cookies or other information in the first domain “mysafetydomain.com”.

An identifier is used to uniquely identify the content. Any existing technology can be used for generating the identifier for the content. In one embodiment, generation of the identifier includes generation of a random string with enough entropy, i.e >512 bits, and constructed from a cryptographically strong random or pseudo-random number sequence. For example, mje27rvbv1c1spngg6bjofj130u8854nttqv0mg1doc2rfh4b8i6qsqutpd11crqqre3qtcrugevv637511hc uksskhpmtnki9n4ent6ft is one such identifier. The predefined address can be modified using the identifier to generate a unique second address for the content as follows: “www.usergenerated.mysafedomain.com/home/ . . . /mje27rvbv1c1spngg6bjofj130u8854nttqv0mg1 doc2rfh4b8i6qsqutpd11crqqre3qtcrugevv637511hcuksskhpmtnki9n4ent6ft”.

A production environment includes a device having a content management system. The device can be of the user or the administrator. The content management system is a fully automated system for managing content upload and content retrieval without intervention of a user or an administrator. The automation is achieved by including a filter in content management system. The filter is configured with the predefined address. The filter receives the request for upload of the content at the first address, generated the identifier and stores the content at the second address determined using the identifier. The storing of the content at the second address is accompanied by storing a mapping of the second address for the first address. The mapping is achieved by saving a sling: redirect property to “www.mysafedomain.com/home” having value of “www.usergenerated.mysafedomain.com/home/ . . . /mje27rvbv1c1spngg6bjofj130u8854nttqv0mg1doc2rfh4b8i6qsqutpd11crqqre3qtcrugev v637511hcuksskhpmtnki9n4ent6ft” return a 307 redirect to “www.usergenerated.mysafedomain.com/home/ . . . /mje27rvbv1c1spngg6bjofj130u8854nttqv0mg1doc2rf h4b8i6qsqutpd11crqqre3qtcrugevv637511hcuksskhpmtnki9n4ent6ft”. In one or more embodiments, the second domain “www.usergenerated.com” is a cookieless domain. The value for “www.usergenerated.com” is configured in an OSGi configuration. The “www.usergenerated.com” is also an access control list (ACL) free domain.

In a developer or a development environment, the device including the content management system or a server including the content management system runs under localhost domain which is the first domain. Any other local IP address such as “127.0.0.1/some-secret-identifier-for-this-upload” is the second address in the second domain. The solution works out of the box also in a local development environment where the second domain “www.usergenerated.mysafedomain.com” is out of reach. It requires no configuration neither in the developer's operating system nor in the software used for development. In this environment, when the user connects using localhost the local physical address, such as 127.0.0.1/192168.x.x is used as the second address in the second domain. The way it works is that the user, such as a developer is logged in using localhost:4502. This indicates that the cookies are associated with localhost. The cookieless domain, i.e. the second domain, in this case is the loopback 127.0.0.1 of the local IP address, such as 10.132.4.25. The browser considers localhost, i.e. the first domain, different than the second domain “127.0.0.1” or “10.132.4.25” making the cookieless domain local.

A user as used herein refers to a person or an entity who wants to upload or retrieve content. Examples of the user include, but are not limited to, an administrator, a developer and the like.

A device of the user herein refers to a developer machine or a user machine or an administrator machine having a content management system present therein. The content management system provides workflows for content upload and content retrieval, and automatically performs the content upload and content retrieval using the methods described herein.

In the following discussion, an “Example Environment” is first described that is operable to employ methods described herein. Following this, a section entitled “Example Methods” describes examples of methods in accordance with one or more embodiments. “Example Apparatuses” describes examples of apparatuses in accordance with one or more embodiments.

### Example Environment

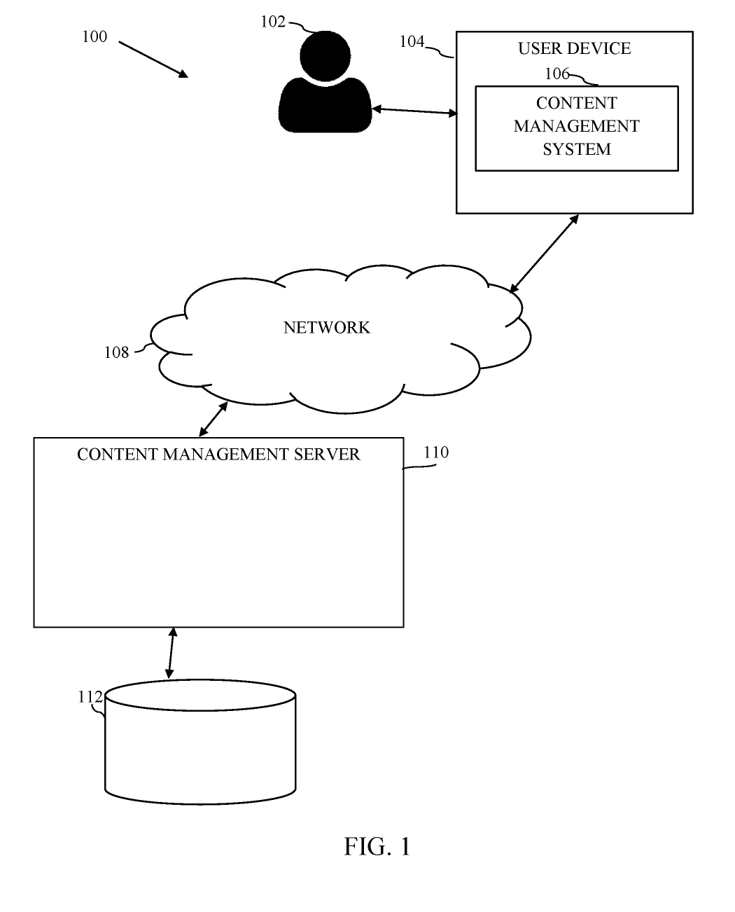

FIG. 1 is a diagram of an environment 100 for managing content upload and content retrieval, according to one or more embodiments. The environment 100 includes a user device 104 using which a user 102 accesses a content management system 106. In illustrated embodiment, the user device 104 includes the content management system 106 using which the user 102 sends a request to upload first content at a first address in a first domain. The content management system 106 can be a standalone application or can be accessed via a browser running on the user device 104.

The request is received by the content management system 106 and the content management system 106 generates a first identifier for the first content. Any existing technology or algorithm can be used for generating a unique identifier for the first content. The content management system 106 then determines a second address in a second domain using the first identifier. The second address is determined by identifying a predefined address configured in the content management system 106. The predefined address is modified by using the first identifier. In one embodiment, modifying includes appending the first identifier to the predefined address to determine the second address. The content management system 106 then causes to store the first content at the second address.

In one embodiment, causing to store includes sending the first content to a content management server 110 via a network 108. The content management server 110 can then store the first content in a storage device 112 at the second address. The storage device 112 can be accessed directly or via the network 108 by the content management server 110. In another embodiment, the causing to store includes storing the first content by the content management system 106.

The content management system 106 is a client end component of the content management server 110 and works in conjunction with the content management server 110.

The storing includes storing the first content, mapping of the second address against the first address for the first content, and other details needed for serving first content from the second address when a request for the first content is directed to the first address.

The content management system 106 then receives a request for the first content directed to the first address. The content management system identifies that a mapping exists for the first content being present at the second address and hence, the content management system 106 accesses the first content from the second address and serves the first content to the user.

In some embodiments, the request for the first content directed to the first address can be sent by a different user, i.e. user different than the user 102 or a different user device. In such cases, an instance of the content management system 106 running at other user's device can serve the first content from the second address.

The second domain is different than the first domain and hence, processes running in the second domain do not have access to the processes in the first domain, and vice versa. So, even if request for upload of malicious content is received at the first address the malicious content is uploaded at the second address and served from there. This prevents the malicious content running in the second domain to access any other content of the first address and prevents access to cookies and other users' sessions in the first domain. For example, the content uploaded to the first address “www.mysafedomain.com/home/malicioususer/upload.js” by the user is not directly downloaded through the first address. A HTTP redirect ends up on the second address “usergenerated.mysafedomain.com/some-secret-identifier-for-this-upload”. Therefore, the malicious content, i.e. the executed JavaScript code, runs in the second domain “usergenerated.mysafedomain.com” rather than the first domain “www.mysafedomain.com”. While the user is logged into under the first domain “www.mysafedomain.com” using a browser all confidential content, such as cookies are available at the first domain, however, the malicious content is accessed through the second domain “usergenerated.mysafedomain.com” and hence no confidential content is available to the user or to the malicious content due to browsers origin policy. Under the browsers origin policy, a browser does not provide access to content in the first domain by a process running in the second domain. Therefore, no session exists on the first domain and the malicious content cannot extract any data or access the first domain under the logged in identity.

In some embodiments, the content management system 106 also receives a request for uploading a second content to the first address in the first domain. The request for uploading the second content can be from the same user or different user. The content management system 106 generates a second identifier for the second content. The second identifier uniquely identifies the second content. The content management system 106 then modifies the predefined address using the second identifier to generate a third address in the second domain. The content is uploaded at the third address and a mapping of the third address is stored against the first address for the second content. Whenever a request for the second content directed to the first address is received, the second content is fetched from the third address and provided to the user.

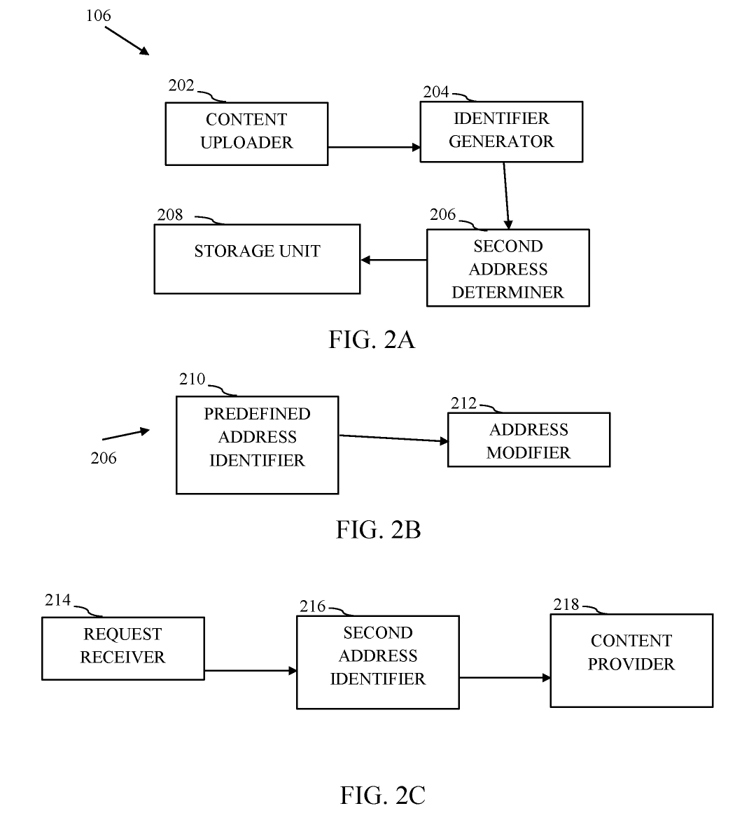

The content management system 106 includes one or more components for managing the content upload and content retrieval and is explained in detail in conjunction with FIG. 2A, FIG. 2B, and FIG. 2C.

It is to be appreciated that the functioning of the content management system 106 can also be performed by the content management server 110 or by a combination of the content management system 106 and the content management server 110 or by the content management system 106 alone.

### Example Apparatuses

FIG. 2A is a block diagram of an apparatus, such as the content management system 106 or the content management server 110, for managing content upload, in accordance to one embodiment.

The apparatus includes a content uploader 202 for uploading the first content to the first address in the first domain. The content uploader 202 receives the request and passes the information to an identifier generator 204. The identifier generator 204 generates a unique identifier (first identifier) for the first content using any existing technology or algorithm. A second address determiner 206 then determines the second address. For determining the second address, the second address determiner includes a predefined address identifier 210 (as shown in FIG. 2B) that identifies the predefined address configured in the apparatus. An address modifier 212 (as shown in FIG. 2B) then modifies the predefined address using the first identifier to determine the second address. In one embodiment, the address modifier 212 appends the first identifier to the predefined address to determine the second address. A storage unit 208 then causes to store the first content at the second address and a mapping for the first address including the second address.

FIG. 2C is a block diagram of an apparatus, such as the content management system 106 or the content management server 110, for managing content retrieval, in accordance to one embodiment.

The apparatus includes a request receiver 214 for receiving the request for the first content. The request is directed to the first address in the first domain.

The apparatus also includes a second address identifier 216 that identifies the second address in the second domain in response to the request for the first content. The second address is identified from the mapping stored for the first address for the first content. The first content is then provided from the second address by a content provider 218.

In some embodiments, the content uploader 202 also receives a request for uploading a second content to the first address in the first domain. The request for uploading the second content can be from the same user or different user. The identifier generator 204 generates a second identifier for the second content. The second identifier uniquely identifies the second content. The address modifier 212 then modifies the predefined address using the second identifier to generate a third address in the second domain. The content is uploaded at the third address and a mapping of the third address is stored against the first address for the second content by the storage unit 208. Whenever a request for the second content directed to the first address is received by the request receiver 214, the second content is fetched from the third address and provided to the user by the content provider 218.

### Hardware Description of Apparatus

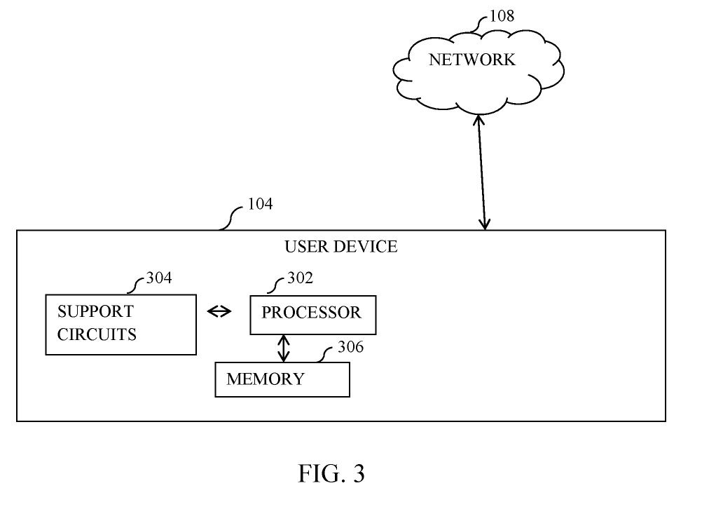

FIG. 3 is a block diagram of an apparatus, such as the user device 104, for managing content upload and content retrieval, according to one embodiment.

The user device 104 is connected to the network 108 and also to the content management server 110 via the network 108. The user device 104 is capable of accessing the Internet, such as the World Wide Web. The user device 104 takes on a variety of forms, such as a personal computer (PC), a server, a desktop computer, a processing unit, any combination of these devices, or any other suitable device having one or more processors. Further, the user device 104 includes one or more processors 302, and one or more computer-readable media. The computer-readable media may include computer-readable instructions executable by the one or more processors 302. The one or more processors 302 further includes multiple elements, for examples as shown in FIG. 2A, FIG. 2B and FIG. 2C, to perform various portions or steps of the method described herein.

The user device 104 includes one or more processors 302 (also referred to as the processors 302), support circuits 304, and a memory 306. The processors 302 include one or more commercially available microprocessors or microcontrollers that facilitate data processing and storage. The various support circuits 304 facilitate the operation of the processors 302 and include one or more clock circuits, power supplies, cache, input/output circuits, and the like. The memory 306 includes at least one of Read Only Memory (ROM), Random Access Memory (RAM), disk drive storage, optical storage, removable storage or the like. The memory 306 includes an operating system, and a processing engine. The operating system 306 includes various commercially known operating systems.

The user device 104 may further include one or more input devices connected to the user device 104. Examples of the one or more input devices include, but are not limited to, peripheral devices, keyboard, mouse etc. In some embodiments, the user device 104 may not be connected to the input devices separately and may have functionalities of these input devices built into the user device 104, such as in cases in which the user device 104 is touch enabled device, gesture enabled device, or paired to such similar devices that act as the input devices.

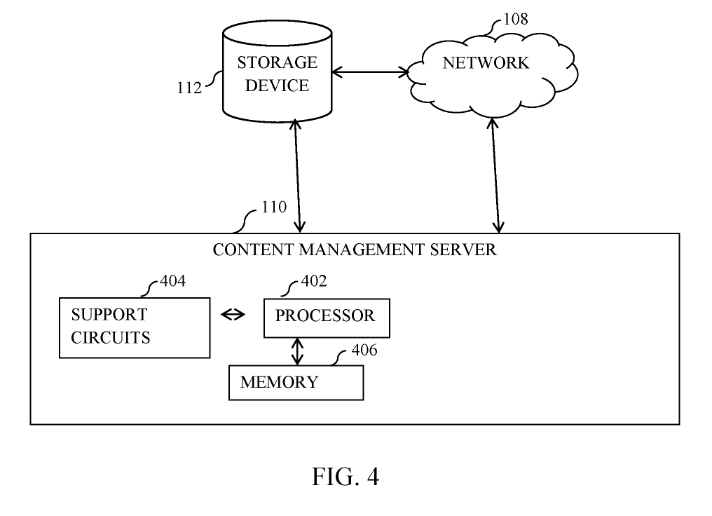

FIG. 4 is a block diagram of an apparatus, such as the content management server 110, according to one embodiment.

The content management server 110 is connected to the storage device 112 via the network 108, or directly. In some embodiments, the content management server 110 includes the storage device 112, such as a local hard drive. The content management server 110 is capable of accessing the Internet, such as the World Wide Web. The content management server 110 takes on a variety of forms, such as a personal computer (PC), tablet computer, a desktop computer, a processing unit, any combination of these devices, or any other suitable device having one or more processors. Further, the content management server 110 includes one or more processors 402 and one or more computer-readable media. The computer-readable media may include computer-readable instructions executable by the one or more processors 402. The one or more processors 402 further includes multiple elements, for examples as shown in FIG. 4, to perform various portions or steps of the method described herein.

The content management server 110 includes one or more processors 402 (also referred to as the processors 402), support circuits 404, and a memory 406. The processors 402 include one or more commercially available microprocessors or microcontrollers that facilitate data processing and storage. The various support circuits 404 facilitate the operation of the processors 402 and include one or more clock circuits, power supplies, cache, input/output circuits, and the like. The memory 406 includes at least one of Read Only Memory (ROM), Random Access Memory (RAM), disk drive storage, optical storage, removable storage or the like. The memory 406 includes an operating system, and a processing engine. The operating system 406 includes various commercially known operating systems.

The content management server 110 may further include one or more input devices connected to the user device 208. Examples of the one or more input devices include, but are not limited to, peripheral devices, keyboard, mouse etc. In some embodiments, the content management server 110 may not be connected to the input devices separately and may have functionalities of these input devices built into the user device 208, such as in cases in which the content management server 110 is touch enabled device, gesture enabled device, or paired to such similar devices that act as the input devices.

### Example Methods

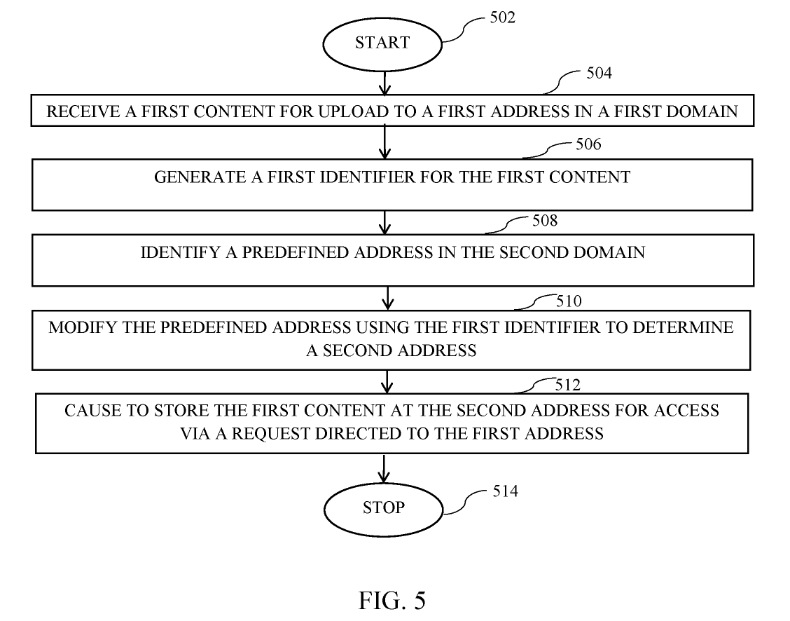

FIG. 5 is a flowchart of a method for managing content upload, according to one embodiment.

In one embodiment, the method is performed by the user device 104. In another embodiment, the method is performed by a combination of the user device 104 and the content management server 110. In yet another embodiment, the method is performed by the content management server 110.

The method starts at step 502 and proceeds to step 504.

At step 504, a request is received to upload the first content to the first address in the first domain.

At step 506, the first identifier is generated for the first content using any existing technology or algorithm.

At step 508, the predefined address is identified in the second domain from a configured filter that is configured with the predefined address.

At step 510, the predefined address is modified using the first identifier to determine the second address in the second domain.

The second domain is different than the first domain and hence, processes running in the second domain do not have access to the processes in the first domain, and vice versa. So, even if request for upload of malicious content is received at the first address the malicious content is uploaded at the second address and served from there. This prevents the malicious content running in the second domain to access any other content of the first address and prevents access to cookies and other users' sessions in the first domain. For example, the content uploaded to the first address “www.mysafedomain.com/home/malicioususer/upload.js” by the user is not directly downloaded through the first address. A HTTP redirect ends up on the second address “usergenerated.mysafedomain.com/some-secret-identifier-for-this-upload”. Therefore, the malicious content, i.e. the executed JavaScript code, runs in the second domain “usergenerated.mysafedomain.com” rather than the first domain “www.mysafedomain.com”. While the user is logged into under the first domain “www.mysafedomain.com” using a browser all confidential content, such as cookies are available at the first domain, however, the malicious content is accessed through the second domain “usergenerated.mysafedomain.com” and hence no confidential content is available to the user or to the malicious content due to browsers origin policy. Under the browsers origin policy, a browser does not provide access to content in the first domain by a process running in the second domain. Therefore, no session exists on the first domain and the malicious content cannot extract any data or access the first domain under the logged in identity.

At step 512, the first content is stored at the second address for access via a request directed to the first address in the first domain.

The method stops at step 514.

In some embodiments, a request for uploading the second content to the first address in the first domain is also received. The request for uploading the second content can be from the same user or different user. The second identifier is generated for the second content. The second identifier uniquely identifies the second content. The predefined address is modified using the second identifier to generate the third address in the second domain. The content is uploaded at the third address and the mapping of the third address is stored against the first address for the second content. Whenever a request for the second content directed to the first address is received, the second content is fetched from the third address and provided to the user.

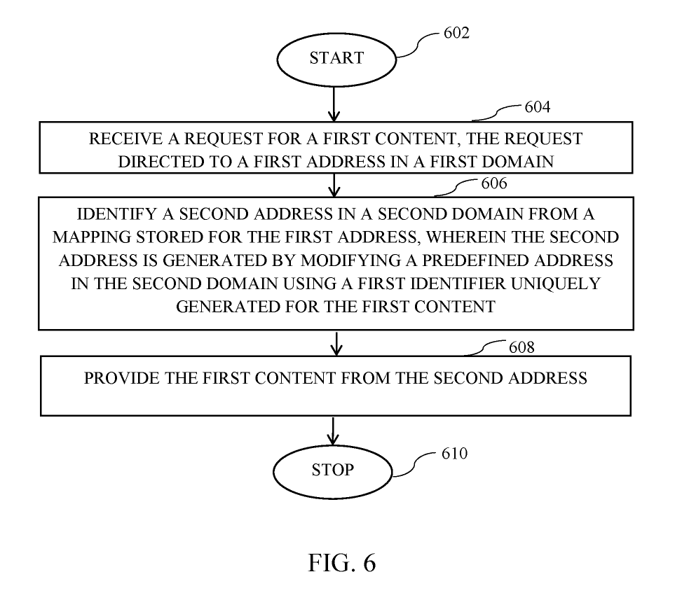

FIG. 6 is a flowchart of a method for managing content retrieval, according to one embodiment.

In one embodiment, the method is performed by the user device 104. In another embodiment, the method is performed by a combination of the user device 104 and the content management server 110. In yet another embodiment, the method is performed by the content management server 110.

The method starts at step 602 and proceeds to step 604.

At step 604, a request directed to the first address is received for the first content.

At step 606, the second address in the second domain is identified from the mapping stored for the first address. The second address is generated as described in FIG. 5.

At step 608, the first content is then provided from the second address.

The method stops at step 610.

In some embodiments, a request for the second content directed to the first address in the first domain is also received. The third address in the second domain is identified from the mapping stored for the first address. The third address is determined as described in FIG. 5. The second content is then provided from the third address.

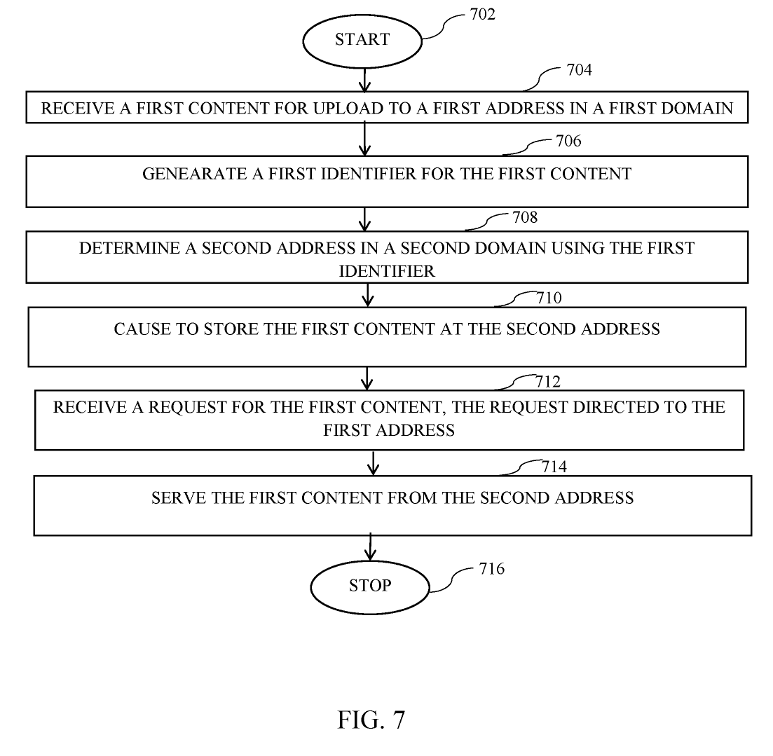

FIG. 7 is a flowchart of a method for managing content upload and content retrieval, according to one embodiment.

In one embodiment, the method is performed by the user device 104. In another embodiment, the method is performed by a combination of the user device 104 and the content management server 110. In yet another embodiment, the method is performed by the content management server 110.

The method starts at step 702 and proceeds to step 704.

At step 704, a request is received to upload the first content to the first address in the first domain.

At step 706, the first identifier is generated for the first content.

At step 708, the second address in the second domain is determined. The second address is determined as described in FIG. 5.

At step 710, the first content is stored at the second address for access via a request directed to the first address in the first domain.

At step 712, a request for the first content directed to the first address is received.

At step 714, the first content is served from the second address.

The method stops at step 716.

In some embodiments, a request for uploading the second content to the first address in the first domain is also received. The request for uploading the second content can be from the same user or different user. The second identifier is generated for the second content. The second identifier uniquely identifies the second content. The predefined address is modified using the second identifier to generate the third address in the second domain. The content is uploaded at the third address and the mapping of the third address is stored against the first address for the second content. Whenever a request for the second content directed to the first address is received, the second content is fetched from the third address and provided to the user.

It is to be appreciated that various steps of FIG. 5, FIG. 6 and FIG. 7 are described in conjunction with term descriptions and example apparatuses.

The embodiments of the present invention may be embodied as methods, apparatus, electronic devices, and/or non-transient or non-transitory computer program products or computer readable medium. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable medium having computer-usable or computer-readable program code embodied in the non-transient or non-transitory medium for use by or in connection with an instruction execution apparatus. In the context of this document, a computer-usable or computer-readable medium may be any medium that can contain, store, communicate, propagate, or transport the program for use by or in connection with the instruction execution apparatus, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

Examples of the computer-usable or computer-readable medium include, but are not limited to, an electronic, magnetic, optical, electromagnetic, infrared, or semiconductor apparatus, apparatus, device, or propagation medium. More specific examples (a non-exhaustive list) of the computer-readable medium or non-transient computer-readable medium or non-transitory computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like or in scripting language, such as Perl, Python, PHP, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance.

In the foregoing detailed description, numerous specific details are set forth to provide a thorough understanding of claimed subject matter. However, it will be understood by those skilled in the art that claimed subject matter may be practiced without these specific details. For example, the claimed subject matter may be practiced by using different gestures or icons than that described. In other instances, methods or apparatuses that would be known by one of ordinary skill have not been described in detail so as not to obscure claimed subject matter.

Some portions of the detailed description are presented in terms of algorithms or symbolic representations of operations on binary digital signals stored within a memory of a specific apparatus or specific electronic device or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Unless specifically stated otherwise, as apparent from the following discussion, it is appreciated that throughout this specification discussions utilizing terms such as “processing,” “displaying,” “receiving,” “providing” or the like refer to actions or processes of a specific apparatus, such as a special purpose computer or a similar special purpose electronic device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic device.

Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method for managing content upload and content retrieval, the method comprising:
receiving a first content for upload to a first address in a first domain;
generating a first identifier for the first content;
determining a second address in a second domain using the first identifier;
causing to store the first content at the second address;
receiving a request for the first content, the request directed to the first address; and
serving the first content from the second address.

2. The method as claimed in claim 1, wherein the first content comprises at least one of an executable file, a malicious script, or malicious data.

3. The method as claimed in claim 1, wherein processes running at the second address do not have access to the first address.

4. The method as claimed in claim 1, wherein determining comprises:
identifying a predefined address in the second domain; and
modifying the predefined address using the first identifier to determine the second address.

5. The method as claimed in claim 1, wherein the second domain is at least one of:
a cookieless domain; or
an access control list free domain.

6. The method as claimed in claim 1 and further comprising:
storing the second address in a mapping for the first address.

7. The method as claimed in claim 1 and further comprising:
receiving a second content for upload to the first address in the first domain;
generating a second identifier for the second content;
determining a third address in the second domain using the second identifier;
causing to store the second content at the third address;
receiving a request for the second content, the request directed to the first address; and
serving the second content from the third address.

8. An apparatus for managing content upload, the apparatus comprising:
one or more processors;
a non-transitory computer readable medium storing instructions, that when executed by the one or more processors, cause the apparatus to perform:
receiving a first content for upload to a first address in a first domain,
generating a first identifier for the first content,
identifying a predefined address in the second domain;
modifying the predefined address using the first identifier to determine a second address, and
causing to store the first content at the second address for access via a request directed to the first address.

9. The apparatus as claimed in claim 8, wherein the first content comprises at least one of an executable file, a malicious script, or malicious data.

10. The apparatus as claimed in claim 8, wherein processes running at the second address do not have access to the first address.

11. The apparatus as claimed in claim 8, wherein the instructions, when executed by the one or more processors, further cause the apparatus to perform:
receiving the request for the first content, the request directed to the first address; and
serving the first content from the second address.

12. The apparatus as claimed in claim 8, wherein the second domain is at least one of:
a cookieless domain; or
an access control list free domain.

13. The apparatus as claimed in claim 8, wherein the first content is received from a first user device and the request for the first content is received from a second user device.

14. The apparatus as claimed in claim 8, wherein the instructions, when executed by the one or more processors, further cause the apparatus to perform:
storing the second address in a mapping for the first address.

15. The apparatus as claimed in claim 8, wherein the instructions, when executed by the one or more processors, further cause the apparatus to perform:
receiving a second content for upload to the first address in the first domain;
generating a second identifier for the second content;
identifying the predefined address in the second domain;
modifying the predefined address using the second identifier to determine a third address in the second domain;
causing to store the second content at the third address.

16. The apparatus as claimed in claim 15, wherein the instructions, when executed by the one or more processors, further cause the apparatus to perform:
receiving a request for the second content, the request directed to the first address; and
serving the second content from the third address.

17. A non-transitory computer readable medium for storing computer instructions that when executed by at least one processor causes the at least one processor to perform a method for managing content retrieval, the method comprising:
receiving a request for a first content, the request directed to a first address in a first domain;
identifying a second address in a second domain from a mapping stored for the first address, wherein the second address is generated by modifying a predefined address in the second domain using a first identifier uniquely generated for the first content; and
providing the first content from the second address.

18. The non-transitory computer readable medium as claimed in claim 17, wherein processes running at the second address do not have access to the first address.

19. The non-transitory computer readable medium as claimed in claim 17, wherein the method further comprises:
receiving the first content for upload to the first address in the first domain;
generating the first identifier for the first content;
determining the second address in the second domain using the first identifier; and
causing to store the first content at the second address and the second address in a mapping for the first address.

20. The non-transitory computer readable medium as claimed in claim 17, wherein the method further comprises:
receiving a request for a second content, the request directed to the first address in the first domain;
identifying a third address in the second domain from the mapping stored for the first address, wherein the third address is generated by modifying the predefined address in second domain using a second identifier uniquely generated for the second content; and
providing the second content from the third address.
